(19) United States
(12) Patent Application Publication
(10) Pub. No.: US 2007/0165882 A1
(43) Pub. Date: Jul. 19, 2007

(54) ADJUSTABLE REPHASE DEVICE FOR COMPRESSION DRIVERS AND DIRECT EMISSION DOME-SHAPED LOUDSPEAKERS

(76) Inventors: Guido NOSELLI, Flero (Brescia) (IT); Stefano Noselli, Flero (Brescia) (IT); Michele Noselli, Flero (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 11/621,247

(22) Filed: Jan. 9, 2007

(30) Foreign Application Priority Data
Jan. 18, 2006 (IT) BS 2006 A 000008

(51) Int. Cl. H04R 3/00

(52) U.S. Cl. 381/111

(57) ABSTRACT

The invention concerns a rephasing device for compression drivers and dome-shaped, direct radiation loudspeakers that comprise a magnetic circuit with a vibrating diaphragm (11) having a dome-shaped part (11′), and a rephasing device (12) made of a non magnetic material, placed in the concavity of the dome-shaped part of said vibrating diaphragm. The rephasing device is supported axially, with respect to the diaphragm, in a movable form and provided with means of adjustment to supply precise adjustment and stability of the distance delineating the volume of a chamber between the diaphragm and rephasing device.

### FIELD OF THE INVENTION

This invention concerns in general compression drivers and direct emission dome-shaped loudspeakers (tweeters) for medium and high frequencies, and refers in particular to an improved rephase for such sound diffusion devices.

### STATE OF THE ART

In FIG. 1A of the enclosed drawings, a simplified scheme of the magnetic circuit 10 is shown, including a vibrating diaphragm 11, with a dome-shaped part 11′, and a rephasing device 12 with annular conduits, of a compression driver according to the state of the art.

In the same way, in FIG. 1B a simplified scheme of the magnetic circuit 13 is shown with vibrating diaphragm 14 and solid rephasing/damper device of a dome-shaped loudspeaker (tweeter) for medium and high frequencies.

The magnetic circuit 13 of the dome-shaped tweeter, even though there are small differences, has the same typology as the magnetic circuit 10 of the compression driver and in both the transducers, always in the compression drivers and occasionally in the dome-shaped tweeters, a particular rephasing device known also as a “phase plug” is however used, which has a double objective.

A first objective is to form a compression chamber 16, between the vibrating diaphragm and the respective rephasing device, to achieve an increase in the sound level produced and to increase the function band of the diaphragm towards higher frequencies. This would be due to the fact that the rephasing device is a solid device placed very close to the vibrating diaphragm and which as a dome-shaped part with a radius of curvature slightly less than that of the diaphragm it is coupled to so as to maintain a well defined, constant distance during the designing process of the component.

When reference is made to compression drivers 10, the rephase device 12 present in the conduits 12′, usually slots at right angles to the diameter of the rephase device or just simple bores, the beginning openings of which have, overall, a reduced area compared with the area of the diaphragm based on a set ratio. Said compression ratio, so that the air between the diaphragm and the solid rephase device is compressed according to the movement of the diaphragm itself before it is made to flow in the conduits through said openings, to then flow into the throat of a trumpet that forms the usual complement so that the diaphragm emits the sound into the air.

The magnitude of the compression is a critical factor for the final frequency response of the assembled component. In the case of a dome-shaped tweeter 13, instead, the rephase device 15 can be without conduits or slots or other outlet air passages between the vibrating diaphragm and rephase device, in that it is the dome-shaped diaphragm itself that emits the sound directly into the air.

The task of the rephasing device then is to compress the air trapped below the diaphragm to such an extent so as to dampen any possible irregularities in the frequency response that the dome-shaped tweeters may present.

A second objective of the rephase device is to progressively transform the sound wave that the compression driver diaphragm, due to its dome shape emits in a spherical form, in a flat sound wave on exiting the rephase device itself, otherwise said throat plane (because it is the plane from which the expansion of a horn to be coupled begins or however a coupling passage for a horn).

The action takes place making the distances the acoustic signal travels from the openings in the rephase device as far as the throat plane itself, equal, resulting in achieving a phase coherence on the throat plane of all the signals that travel separately along each individual passage and they exclude, or at least reduce, destructive interferences due to differences in route.

Achieving perfectly equal distances in the passages is not an important critical factor, because also differences of a few millimetres between one passage and another do not cause serious destructive interferences in the sound band the component has to reproduce.

It is well known in fact that to have interference there must be differences in travel of at least ½ a sound wave length.

For example, at 20,000 Hz, the highest frequency that a compression driver or dome-shaped tweeter is required to produce, the length of the wave is about 17 mm.

Consequently, ½ the length of a sound wave is 8.5 mm, therefore the interference would go out of the frequency band compared with the one used for reproduction, with differences that, should they happen will remain within this length. In the case of the dome-shaped tweeter there are no sound paths to be followed in the possible passages present in the rephasing device simply because the sound is already emitted directly into the air by the diaphragm.

In fact, for both types of components, the magnetic circuit and diaphragm, have, for the sake of clarity been illustrated schematically in FIGS. 1A and 1B, without the other surrounding parts such as the closing cover of the driver or the anchoring flange of the dome-shaped tweeter. The greatest operating critical factor in order to achieve the high frequency auspicated results is found in the choice of positioning distance of the rephasing device compared with the vibrating diaphragm, provided that all the other critical factors connected with the design of the magnetic circuit and the parts that comprise the diaphragm, have been resolved.

Such a distance, generally in the case of components which must reproduce the high frequencies and not only the medium ones, is in the order of a few tenths of a millimetre, on the average from 0.4 to 0.5 mm.

Therefore a variation of only a tenth of this distance, moves the vibrating frequency of the volume of air that forms between the rephasing device and the vibrating diaphragm, altering, sometimes very noticeably, the frequency response of the compression driver or direct radiation dome-shaped tweeter, above all, but not restricted to, the sound band over 10,000 Hz.

This undesirable condition occurs very often in devices taken into consideration in this invention, due to the construction differences of their individual parts and above all because these differences have repercussions on the final assembly so much so as to result in a product differing one from the other.

### OBJECTS OF THE INVENTION

An object of this invention is to provide a way of resolving the problem complained about above in a simple and effective way not only in the assembly phase of a compression driver or a dome-shaped tweeter during production in the factory, but also later, should a replacement of the damaged diaphragm be required by the end user.

Another object of the invention is therefore to create the conditions to reach regular acoustic performances of the compression driver and dome-shaped tweeter, above all from the regularity and amplitude of the frequency response point of view, in general not easy to achieve due to the dimensional variations, construction tolerances and assembly, dilatation of the component parts, plus other factors.

These objectives are achieved, according to the invention, by associating the vibrating diaphragm of a compression driver or a dome-shaped loudspeaker with a movable rephasing device equipped with means for positioning it with regards to said diaphragm in order to achieve a precise adjustment of the distance delineating the compression chamber between the diaphragm and rephasing device.

Such an adjustment can be carried out not only at the start using tools during production but, advantageously, also by the end user, who, without the need for pertinent mechanical measuring instruments, can assemble a replacement diaphragm and adapt the position of the rephasing device simply by measuring the frequency response of the system, using, for example, a simple spectrum analyser, an instrument belonging today to the majority of users who adopt a compression driver or a dome-shaped tweeter.

### BRIEF DESCRIPTION OF THE DRAWINGS

The invention will, however, be described in detail from this point on in relation to a compression driver and referring to the attached drawings, in which:

FIGS. 1A and 1B show, respectively, a compression driver and a dome-shaped loudspeaker according to the state of the art described above;

FIG. 2A shows a classic magnetic circuit of a compression driver with a rephasing configuration that adapts to the diaphragm by means of a spacer 17 during assembly and is then glue fixed.

FIG. 3 shows a blow-up view of the of the crucial components of a loudspeaker according to the invention;

FIG. 4 shows a cross section view of the separate components shown in FIG. 3; and

FIG. 5 shows a cross-section of the assembled loudspeaker.

### DETAILED DESCRIPTION OF THE INVENTION

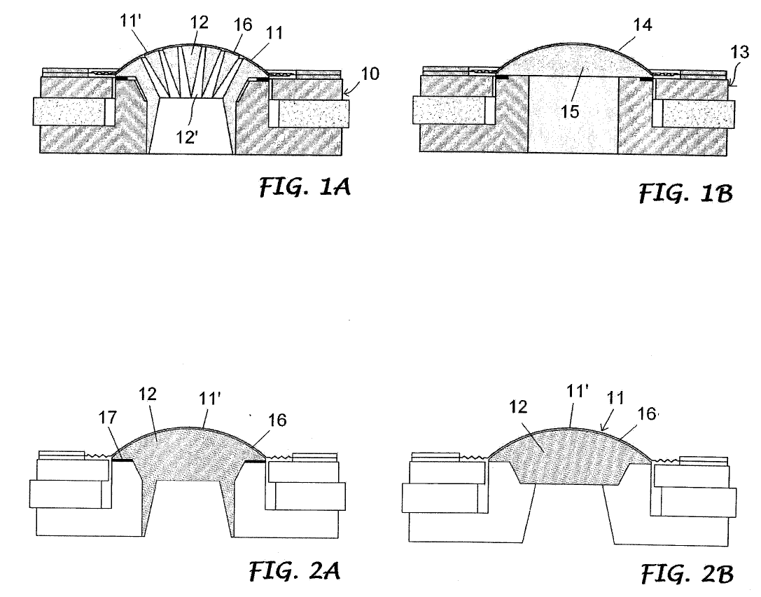

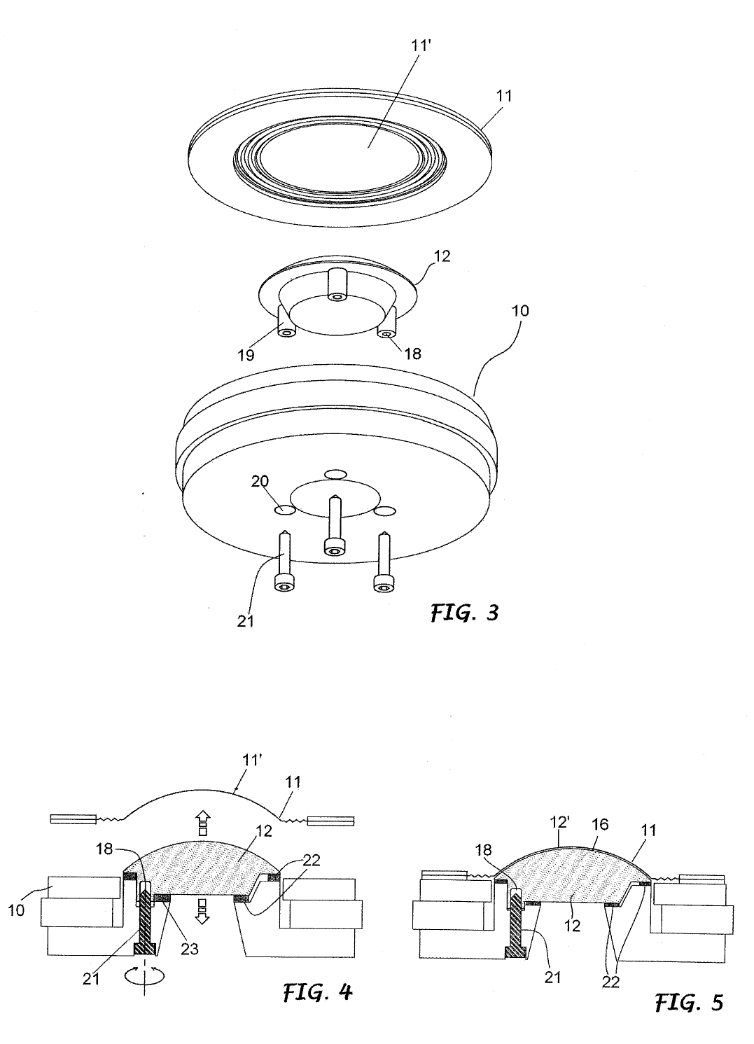

For the sake of simplicity, in the description of FIGS. 3 to 5 which are indicative of the invention the same reference numbers are used to indicate similar or equivalent parts to those that comprise the devices of the state of art of FIG. 1A.

Consequently, also in FIGS. 3 to 5 number 10 indicates the magnetic circuit with a vibrating diaphragm 11 having a dome-shaped central part 11′. Inside the concavity of said diaphragm 11, is inserted a solid rephasing device 12 between the vibrating diaphragm 11 and the circuit 10, having a dome-shaped surface facing the dome-shaped part 11′ of the diaphragm and designed to delineate a compression chamber 16 between itself and the diaphragm and to act as a damping element of unwanted resonant behaviour.

The rephasing device 12 according to the invention has, however, some threaded holes 18, at least three, provided preferably in the same number of equidistant legs 19 extending from the rephasing device in the opposite direction to the diaphragm.

The legs 19, consequently the threaded holes 18 of the rephasing device 12, coincide with the holes 20 provided in the supporting body 13 and provided to receive an equivalent number of adjustment screws 21 to be screwed into said threaded bores.

In substance, the rephasing device 12 is movable with regards to the diaphragm 11, and by tightening or loosening the adjustment screws 21, it is possible to vary the position of said device, by adjusting and establishing the distance from the internal surface of the dome-shaped part of the diaphragm, according to the need.

The movement of the adjustment screws 21 can be opposed by one or more rubber gaskets 22 placed between the rephasing device 12 and a stop surface 23 by means of which it can rest on the supporting body 13 as shown in FIGS. 3 and 4.

The gasket or gaskets 23 therefore have the dual function:
of holding the rephasing device in position even when it is not at the end of its stroke, and
of expanding or compressing, to form a seal against possible unwanted air flow between the gap and the exit passage towards the horn of the system.

Such an adjustment system can, not only be applied to any type of rephasing device present on the market for compression drivers, but also for dome-shaped, direct radiation loudspeakers.

1. Rephasing device for compression drivers and dome-shaped, direct radiation loudspeakers that comprise a magnetic circuit with a vibrating diaphragm having a dome-shaped part, and with a rephasing device made of a non magnetic material, placed in the concavity of the dome-shaped part of said vibrating diaphragm, wherein the rephasing device is supported axially, with respect to the diaphragm, in a movable form and provided with means of adjustment to supply precise adjustment and stability of the distance delineating the volume of a chamber between the diaphragm and rephasing device.

2. Rephasing device according to claim 1, in which threaded bores are formed at right angles to the resting surface of the diaphragm and through adjusting screws in a rigid support and inserted in said threaded bores, said screws being tightened or loosened to move the rephasing device towards or away from the vibrating diaphragm.

3. Rephasing device according to claim 2, in which said threaded bores are provided in an equivalent number of legs protruding from the rephasing device in the opposite direction to the diaphragm, and in which, holes to receive the registration screws coinciding with said legs are provided in the diaphragm support.

4. Rephasing device according to claim 1, in which at least one rubber gasket, compressible into different sizes according to the variation in the position of the rephasing device with respect to the vibrating diaphragm, is positioned between the rephasing device and its face on said support.

5. Compression driver characterized in that it comprises an axially supported rephasing device which is equipped with means of adjustment to supply precise adjustment and stability of its distance from the diaphragm according to claim 1.

6. Dome-shaped loudspeaker (tweeter) characterized in that it comprises an axially supported rephasing device which is equipped with means of adjustment to supply precise adjustment and stability of its distance from the diaphragm according to claim 1.

7. Compression driver characterized in that it comprises an axially supported rephasing device which is equipped with means of adjustment to supply precise adjustment and stability of its distance from the diaphragm according to claim 2.

8. Compression driver characterized in that it comprises an axially supported rephasing device which is equipped with means of adjustment to supply precise adjustment and stability of its distance from the diaphragm according to claim 3.

9. Compression driver characterized in that it comprises an axially supported rephasing device which is equipped with means of adjustment to supply precise adjustment and stability of its distance from the diaphragm according to claim 4.

10. Dome-shaped loudspeaker (tweeter) characterized in that it comprises an axially supported rephasing device which is equipped with means of adjustment to supply precise adjustment and stability of its distance from the diaphragm according to claim 2.

11. Dome-shaped loudspeaker (tweeter) characterized in that it comprises an axially supported rephasing device which is equipped with means of adjustment to supply precise adjustment and stability of its distance from the diaphragm according to claim 3.

12. Dome-shaped loudspeaker (tweeter) characterized in that it comprises an axially supported rephasing device which is equipped with means of adjustment to supply precise adjustment and stability of its distance from the diaphragm according to claim 4.
